(19) United States
(12) Patent Application Publication
(10) Pub. No.: US 2006/0225264 A1
(43) Pub. Date: Oct. 12, 2006

(54) Tow hitch receiver

(76) Inventor: Murali Mahidhara, Pittsburgh, PA (US)

Correspondence Address: RAMA B. NATH, 2530 Quail Run, Lansdale, PA, 19446, US

(21) Appl. No.: 11/101,732

(22) Filed: Apr. 8, 2005

(51) Int. Cl. B23P 17/00; B62K 27/12

(52) U.S. Cl. 29/421.1; 280/292

(57) ABSTRACT

A method of fabricating a tubular tow hitch receiver from a metallic tubular member having known wall thickness and inner tube dimensions, uses forging at one end of the tubular member resulting in a peripheral crown formation extending axially and having a radial thickness at least equal to the tubular wall thickness. The tubular member is flared at its opening to form a single substantially conical surface at an acute angle (e.g., from 3-15 degrees,) with respect to the tubular axis, resulting in a flared opening which is larger than the tube inner dimensions. By the flaring and forging operation, a concave cavity inside the flared opening is obviated, thus avoiding potential water retention and corrosion. The crown formation and the flaring-operations may be combined into a single forging operation. The tubular member may have a square cross section and be made of material conforming to ASTM, A-500 grade B 1020 material.

### FIELD OF THE INVENTION

The present invention generally relates to tow hitch receivers, and more particularly to a method of forming a tubular tow hitch receiver using forging or forming.

### BACKGROUND OF THE INVENTION

Tow hitch receivers have been known to be fabricated out of metallic material which may be tubular or otherwise. It is known to obtain tubular configurations from flat sheet metal by progressive rolling and subjecting the seam to a weld in the rolling operation. Hitch receivers that are manufactured by fabrication from a tubular work piece are often reinforced by additional material at the receiver-opening to add strength. However, the geometry of certain known hitch receiver configurations is such that water can accumulate inside the receiver entrance and promote corrosion. There is need for addressing not only the geometry but also the method of making/fabricating hitch receivers to obviate problems with known types of hitch receivers.

### SUMMARY OF THE INVENTION

One embodiment of the invention consists in a method of fabricating a tubular tow hitch receiver, comprising the steps of: using a metallic tubular member having a known nominal radial thickness and inner tube dimensions; pressure-forming one end of the tubular member make an entrance of said tow hitch receiver and cause a peripheral crown formation having a maximum radial thickness greater than said known nominal radial thickness, said crown formation having an axial length of ‘l’, and, flaring said tow hitch receiver entrance over a second axial length ‘l1’ which is substantially equal to or more than said axial length ‘l’ to form a single flared substantially conical surface at an acute angle with respect to an axis of the tubular member, to result in a flared opening which is larger than said tubular inner tube dimensions.

A second embodiment resides in a method of making a tow hitch receiver comprising the steps of: starting with a tubular member having a known nominal radial thickness and inner dimensions; forging one end of said tubular member to make an entrance of said tow hitch receiver by forming a peripheral crown formation with a maximum radial thickness more than said nominal radial thickness; limiting an axial length of said crown formation to an axial length ‘l’; and, flaring said entrance of the tow hitch receiver over a second axial length ‘l1’ which is at least equal to said first axial length ‘l’ to form a single substantial conical surface at an acute angle with respect to an axis of said tubular member so as to obtain a flared hitch opening which has dimensions larger than said tubular member inner dimensions.

Another embodiment resides in a tow hitch receiver comprising: a metallic tubular member having a known nominal radial wall thickness and inner tube dimensions; a peripheral crown formation formed integrally with the tubular member at one end of the tubular member, said crown formation having a radial thickness at least equal to said nominal radial wall thickness and first axial length, said one end of the tubular member forming an opening for the tow hitch receiver; and, a flared configuration formed at said opening, said flared configuration having a second axial length and a single substantially conical surface converging from said opening into the tubular member and making an acute angle with an axis of the tubular member, said second axial length being substantially equal to said first axial length, said tow hitch receiver opening being larger than said inner tube dimensions. In one embodiment, the second axial length is more than the first axial length.

The acute angle may be chosen as per design requirements, and it is noted that a preferred angle in one embodiment was approximately 12 degrees. Additionally, the crown formation may have its maximum radial depth at the tow hitch receiver entrance, and have a configuration that tapers down from the tow hitch receiver entrance towards the receiver inside.

Tow hitch receivers with welded crown formations are available in the market, but are besieged with problems including obsolescence, and high cost. Any welding operation in prior art hitch receivers to reinforce the receiver opening may not be conducive to inexpensive mass production. More significantly, some available tubular hitch receivers are formed with a concavity at the open end of the hitch receiver; the concavity potentially causes water accumulation and consequent corrosion and degradation. In the present approach, the concavity and water collection are obviated because of the flaring to form a single substantially conical surface at an acute angle, and mass production is possible because of the press-forming operation e.g., forging. The forging operation may be cold-forging, or hot-forging, or a selective hybrid of the two. The substantially conical surface may be part of a straight conical surface or may be slightly curved. The crown formation, in the present approach by forging, doubly enhances the mechanical strength of the hitch receiver not only by a thicker cross material cross section of the tubular member, but also, by the work-hardening process, which is inherent in forging. Expediently, by resorting to a single substantially conical flared surface at an acute angle to the axis of the tubular member at the hitch receiver entrance, concavity of the known types of hitch receivers is obviated, thereby improving longevity and performance. The acute angle could be any angle to suit the designer's requirement. However, an acute angle in the range 3-15 degrees is considered desirable. Further, advantageously, the operations of crown forming and providing the flared surface may be combined into a one-step forging operation. Details of the required controls for the forming and forging operations are intelligible to those skilled in the art. It is noted herein that the terms “tow hitch receiver”, “hitch receiver” and “receiver” are all used synonymously in the context of this invention.

The tubular member may be of any suitable configuration, e.g., square, rectangular, circular or oval, or other configurations that may be desirable. The material for the tubular member may be rolled-steel or any other alloy or metal that would lend itself to forging and cold-forming operations. It is conceivable that a flat sheet or strip of material of suitable thickness is formed into the required cross sectional configuration by rolling and seam-welding, e.g., into a square cross section, and then subjected to the forging and flaring operations as taught herein. As shown, the tubular member is of square cross section, and may be of material that conforms to ASTM A-500 grade B 1020 material. It is conceivable that the tubular member may be prepared at both ends for use as a hitch receiver instead of a single end as illustrated in the examples described herein.

### BRIEF DESCRIPTION OF DRAWING

A more detailed understanding of the invention may be had from the following description of certain exemplary embodiments, to be understood in conjunction with the accompanying drawing wherein:

FIG. 1 is an illustration of a prior art tow hitch receiver that uses a tubular member of square cross section;

FIG. 2 is an example of a tow hitch having a welded crown formation; and,

FIG. 3 is an illustration of an exemplary tow hitch receiver fabricated as taught herein.

### DETAILED DESCRIPTION

In the following detailed description of the various embodiments of the invention, reference is made to the accompanying drawings that form a part hereof, and in which are shown by way of illustration of specific embodiments through which the invention may be practiced. These embodiments are described in sufficient detail to enable those skilled in the art to practice the invention, and it is to be understood that other embodiments may be utilized and that changes may be made without departing from the scope of the present invention. The following detailed description is therefore not to be taken in a limiting sense, and the scope of the present invention is defined only by the appended claims and their equivalents.

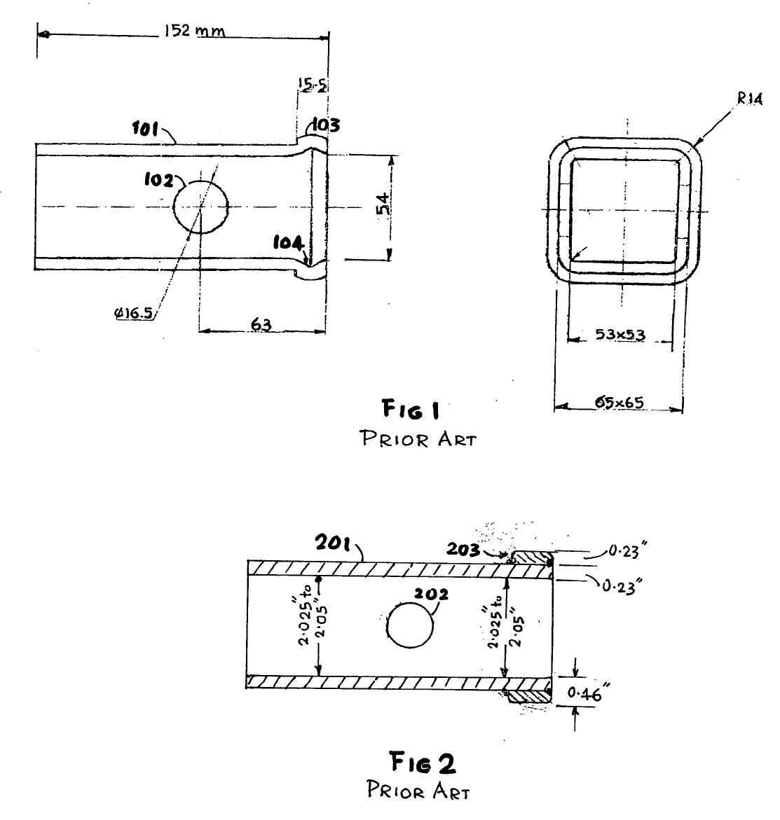

FIG. 1 illustrates a prior art tow hitch receiver which has a tubular body 101, a crested entrance 103, and a fastening hole 102 for a lock pin or the like. In the formation of the crested entrance, a concavity shown at 104 becomes formed, which is undesirable. As aforesaid, the concavity 104 promotes water retention and consequent corrosion.

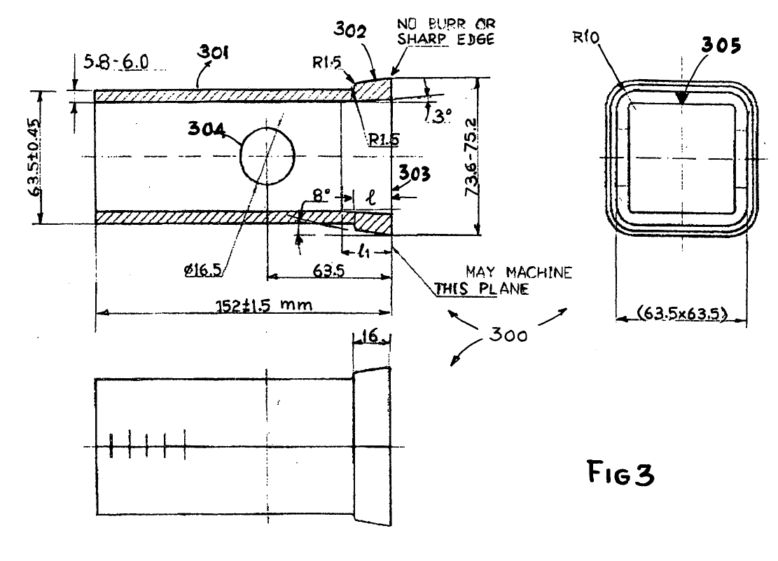

FIG. 2 illustrates another prior art tow hitch receiver, showing a tubular body 201, a fastening hole 202, and a crest formed at the entrance, as shown at 203. The crest 203 is formed as shown, by welding a ring. The inside tubular dimensions are shown in the illustration, and it is noted that the tubular inside surface in this prior art hitch receiver is uniformly straight-cylindrical.

FIG. 3 illustrates an example of the present tow hitch receiver and includes a tubular member 301, a peripheral crown formation 302 and a fastening hole 304 for inserting a locking pin or the like. The crown formation 302 as shown extends over an axial length of ‘l’, and is associated with flaring at the open end of the tubular member 301. The crown formation may either be in the form of a substantially straight slope, or may include a radius with a step-down towards the tubular outer periphery. The flaring is done to form a single substantially conical surface at an acute angle, which preferably ranges from 3 degrees to 15 degrees. In the illustration of FIG. 3, a flaring angle of 3 degrees is shown as an example. In a modification, a flaring angle of 12 degrees was used with good performance results. The axial length ‘l1’ over which the flaring is performed may approximately be equal to or preferably greater than length ‘l’. Other lengths for ‘l1’ may be used as well, depending on the designer's choice, considering that the pressure needed for the forging operation might need to be modified accordingly.

The cross section for the tubular member may be square, rectangular, oval, circular, or any other suitable section. The tow hitch receiver described herein might use a preformed chosen cross section, or, might use a blank sheet metal which is rolled to form a tubular member of the required cross section after seam welding, which is then subjected to the flaring and crown forming operations. The illustration in FIG. 3 shows a tubular member 301 formed by rolling a flat blank, formed into a square cross section and finished by a seam weld 305. The flaring and crown forming operations may be done sequentially, or may be combined into a single forging operation. The dimensions for the tubular member may be chosen based on the design-need, even though in some cases, a nominal 2.5″ square cross section is preferred commercially. Typical dimensions and radii where applicable, are illustrated in FIG. 3 as an example and not a limitation. The crown formation may include a radial depth that progressively reduces away from the receiver-opening to form an outside slope at an angle, e.g., 8 degrees as shown, with respect to the tubular axis. The flared opening of the tow hitch receiver may be machined as necessary to obtain an even surface and remove sharp edges. The material for the tow hitch receiver could be selected from several choices including rolled or mild steel, stainless steel or ferrous alloys, or any other material that has the requisite mechanical strength and lends itself to press forming or forging. Preferably but not necessarily, the material for the tubular member may be material that conforms to ASTM A-500 grade B 1020 material. The forging could be hot forging, cold forging, or a combination of the two. The designer will be able to make a suitable choice of the sequence of flaring and crown formation, and the type of forging, considering the consequences derived by work-hardening that may be available with the cold forging process.

The foregoing is the description of exemplary implementations of the method of fabrication and a tow hitch apparatus that overcome the disadvantages of known type tow hitch receivers. It is noted that the selective flaring operation of the tubular member to form a single flared surface at specific flaring angles obviates the water retention and corrosion problems. The choice of the flaring angle in the range of 3-15 degrees in the illustration is purely exemplary and not intended to be a limitation. It is noted that the flaring angle may be any suitable acute angle. The description of the method of fabrication and the geometry of the tow hitch receiver described hereinabove are intended to be illustrative, and not restrictive.

Many modifications for the method of fabrication and the tow hitch receiver per se will be apparent to those skilled in the art, and are envisaged to be within the ambit of the present invention. The scope of this invention should therefore be determined by the appended claims as supported by the text, along with the full scope of equivalents to which such claims are entitled.

1. A method of fabricating a tubular tow hitch receiver, comprising the steps of:
using a metallic tubular member having a known nominal radial thickness and inner tube dimensions;
pressure-forming one end of the tubular member make an entrance of said tow hitch receiver and cause a peripheral crown formation having a maximum radial thickness greater than said known nominal radial thickness, said crown formation having an axial length of ‘l’, and,
flaring said tow hitch receiver entrance over a second axial length ‘l1’ which is substantially equal to or more than said axial length ‘l’ to form a single flared substantially conical surface at an acute angle with respect to an axis of the tubular member, to result in a flared opening which is larger than said tubular inner tube dimensions.

2. The method as in claim 1, wherein said axial length ‘l’ of the crown formation is 1.5 to 2 times of said nominal radial thickness of the tubular member.

3. The method as in claim 2, including the step of making the crown formation have a radial thickness that gradually reduces away from said maximum at the tow hitch receiver entrance.

4. The method as in claim 2, wherein said axial length ‘l’ of the crown formation is between 2 and 3 times said nominal radial thickness of said tubular member.

5. The method as in claim 1, including the step of machining said entrance of said tow hitch receiver opening in a radial plane.

6. The method as in claim 1, wherein the step of flaring is done to form said single flared substantially conical surface at an acute angle in an approximate range of 3 to 15 degrees with respect to the tubular member axis.

7. The method as in claim 1, wherein the step of pressure forming is done to make the maximum radial thickness of said crown formation to be approximately twice said nominal radial thickness of the tubular member.

8. The method as in claim 1, wherein the step of pressure-forming comprises cold forming by forging, said method including the step of machining a face of the entrance of the tow hitch receiver.

9. The method as in claim 1, wherein the step of pressure-forming and the step of flaring comprise hot forging, said method including the step of machining a face of the flare opening.

10. The method as in claim 1, wherein the steps of pressure-forming and flaring comprise selective hybrid hot and cold forging, said method including the step of machining a face of the flare opening.

11. The method as in claim 1, wherein the step of flaring includes shaping to avoid a concave profile at said flared opening to obviate water retention inside the flared opening.

12. The method as in claim 1, including the step of directing the crown formation to slope away from said flared opening so that the crown formation has maximum radial thickness at an entrance to the flared opening.

13. The method as in claim 1, including combining said pressure forming for the crown formation and the step of flaring, into a single operation.

14. The method as in claim 1, wherein said tubular member is chosen from a group comprising square, rectangular circular and oval configurations.

15. The method as in claim 14, wherein said tubular member comprises a square tube with nominal 2.5″ outside dimensions and 0.23″ nominal radial wall thickness, and is in conformity with ASTM, A-500 grade B 1020 material.

16. A method of making a tow hitch receiver comprising the steps of:
starting with a tubular member having a known nominal radial thickness and inner dimensions;
forging one end of said tubular member to make an entrance of said tow hitch receiver by forming a peripheral crown formation with a maximum radial thickness more than said nominal radial thickness;
limiting an axial length of said crown formation to an axial length ‘l’; and,
flaring said entrance of the tow hitch receiver over a second axial length ‘l1’ which is substantially equal to said first axial length ‘l’ to form a single substantial conical surface at an acute angle with respect to an axis of said tubular member so as to obtain a flared hitch opening which has dimensions larger than said tubular member inner dimensions.

17. The method of clam 16, wherein said acute angle is in an approximate range of 3 to 15 degrees.

18. A tow hitch receiver comprising:
a metallic tubular member having a known nominal radial wall thickness and inner tube dimensions;
a peripheral crown formation formed integrally with the tubular member at one end of the tubular member, said crown formation having a maximum radial thickness at least equal to said nominal radial wall thickness and a first axial length, said one end of the tubular member forming an opening for the tow hitch receiver; and,
a flared configuration formed at said opening, said flared configuration having a second axial length and a single substantially conical surface converging from said opening into the tubular member and making an acute angle with an axis of the tubular member, said second axial length being at least equal to said first axial length, said tow hitch receiver opening being larger than said inner tube dimensions.

19. The tow hitch receiver as in claim 18, wherein the tubular member has a generally square cross section with a nominal dimension of 2.5″, wherein the tubular member is made of material conforming to ASTM, A-500 grade B 1020 material, where said second axial length is greater than said first axial length..

20. The tow hitch receiver as in claim 19, wherein said acute angle is in the approximate range of 3 to 15 degrees.
